(19) United States
(12) Patent Application Publication
(10) Pub. No.: US 2013/0337888 A1
(43) Pub. Date: Dec. 19, 2013

(54) GAMING SYSTEMS AND METHODS FOR USE IN PROVIDING A COMMUNITY GAME

(71) Applicants: Christopher John Thacker, Earlysville, VA (US); Daniel William Milligan, Palmyra, VA (US)

(72) Inventors: Christopher John Thacker, Earlysville, VA (US); Daniel William Milligan, Palmyra, VA (US)

(21) Appl. No.: 13/523,713

(22) Filed: Jun. 14, 2012

(51) Int. Cl. A63F 13/12; A63F 9/24

(52) U.S. Cl. 463/25; 463/42; 463/31

(57) ABSTRACT

Servers and method for use in providing a community game are disclosed. One exemplary gaming system includes a gaming server configured to provide a community game playable by a plurality of players, wherein the community game includes a plurality of game piece locations for displaying a plurality of game pieces. The gaming system also includes a first gaming device and a second gaming device. The first gaming device is configured to present a first primary game to a first player and transmit a first output to the gaming server. The second gaming device is configured to present a second primary game to a second player and transmit a second output to the gaming server. The gaming server provides a first game piece in a first game piece location based on the first output, and provides a second game piece in a second game piece location based on the second output.

### BACKGROUND OF THE INVENTION

The embodiments described herein relate generally to gaming systems and, more particularly, to gaming systems and methods for use in providing a community game.

At least some known gaming machines provide a primary game and a secondary game. For example, a secondary game may include free plays that are associated with a probability of a payout and do not require a player to deposit money or credits to the gaming machine. A secondary game may be triggered by a condition, such as a particular combination of symbols associated with a primary play outcome in the primary game. A number of different secondary games are known. Secondary jackpots are generally used by gaming entities to encourage additional play from one or more players. An example of a secondary game is a progressive jackpot, which incremental grows as players continue to bet at slot machines linked to the progressive jackpot. The progressive jackpots are generally known to being geographically limited to a casino, not guaranteed to payout, and open to any player within the casino.

Another type of secondary game that may be provided by at least some known gaming machines is a community game that is playable by a plurality of players. The gaming machines connect to the community game via a network and enable the players to compete against each other or collaborate together to win a prize or a payout. The community games are often separate from other primary games played on gaming machines, and may provide limited interaction with the primary games and/or the players.

### BRIEF DESCRIPTION OF THE INVENTION

In one aspect, a gaming system is provided that includes a gaming server configured to provide a community game playable by a plurality of players, wherein the community game includes a plurality of game piece locations for displaying a plurality of game pieces. The gaming system also includes a first gaming device and a second gaming device communicatively coupled to the gaming server. The first gaming device is configured to present a first primary game associated with the community game to a first player of the plurality of players, and transmit a first output of the first primary game to the gaming server. The second gaming device is configured to present a second primary game associated with the community game to a second player of the plurality of players, and transmit a second output of the second primary game to the gaming server. The gaming server is further configured to provide a first game piece of the plurality of game pieces in a first game piece location of the plurality of game piece locations based on the first output, and to provide a second game piece of the plurality of game pieces in a second game piece location of the plurality of game piece locations based on the second output.

In another aspect, a method of providing a community game playable by a plurality of players is provided, wherein the community game includes a plurality of game piece locations for displaying a plurality of game pieces. The method includes presenting a first primary game associated with the community game to a first player of the plurality of players, transmitting a first output of the first primary game to a gaming server, presenting a second primary game associated with the community game to a second player of the plurality of players, and transmitting a second output of the second primary game to the gaming server. The method further includes providing a first game piece of the plurality of game pieces in a first game piece location of the plurality of game piece locations based on the first output, and providing a second game piece of the plurality of game pieces in a second game piece location of the plurality of game piece locations based on the second output.

### BRIEF DESCRIPTION OF THE DRAWINGS

FIG. 1 is a perspective view of an exemplary gaming machine.

FIG. 2 is a block diagram of the exemplary gaming machine shown in FIG. 1.

FIG. 3 is a diagram of an exemplary gaming system including a plurality of the gaming machines shown in FIG. 1.

FIG. 4 is a block diagram of an exemplary computing device.

FIG. 5 is a block diagram of an exemplary gaming system that may be used to provide a community game, such as a community bingo game.

FIG. 6 is a block diagram of another exemplary gaming system that may be used to provide a community game, such as a community virtual poker game.

FIG. 7 is a flow diagram of an exemplary method for providing a community game.

### DETAILED DESCRIPTION OF THE INVENTION

Exemplary embodiments of systems and methods for use in providing a community game are described herein. Such embodiments may enhance entertainment aspects of various gaming activities by providing chances to win a secondary game associated with the gaming activities and/or by providing incentives to engage in gaming activities with additional players. One such secondary game may include a community game, such as a community bingo game or a community virtual poker game, which is playable by a group of players.

Exemplary technical effects of systems and methods described herein include at least one of: (a) presenting a first primary game associated with a community game to a first player of a plurality of players; (b) transmitting a first output of a first primary game to a gaming server; (c) presenting a second primary game associated with a community game to a second player of a plurality of players; (d) transmitting a second output of a second primary game to a gaming server; (e) providing a first game piece of a plurality of game pieces in a first game piece location of a plurality of game piece locations based on a first output; and (f) providing a second game piece of a plurality of game pieces in a second game piece location of a plurality of game piece locations based on a second output.

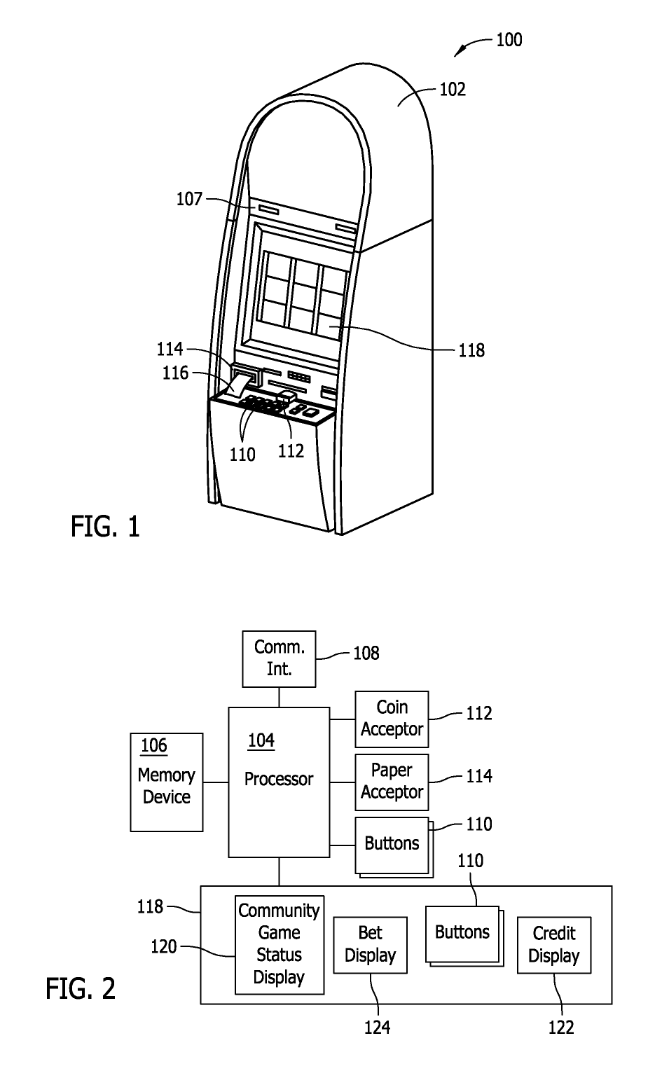

FIG. 1 is a schematic diagram of an exemplary gaming machine 100, which may be any type of gaming machine, and may include different structures than those shown in FIG. 1. In various embodiments, gaming machine 100 includes, without limitation, video bingo machines, video poker machines, video slot machines, and/or other similar gaming machines that implement other recognized casino games.

In the exemplary embodiment, gaming machine 100 includes a cabinet 102 configured to at least partially enclose and/or support a plurality of components, such as a processor, peripheral devices, presentation devices, and player interaction devices. FIG. 2 illustrates a block diagram of at least a portion of the components of gaming machine 100. As shown, gaming machine 100 includes a processor 104 communicatively coupled to a memory device 106. Processor 104 and memory device 106 are enclosed within cabinet 102 (shown in FIG. 1). Gaming machine 100 is configurable and/or programmable to perform one or more operations described herein by programming processor 104. For example, processor 104 may be programmed by encoding an operation as one or more executable instructions and providing the executable instructions in memory device 106. The term processor, as used herein, refers to central processing units, microprocessors, microcontrollers, reduced instruction set circuits (RISC), application specific integrated circuits (ASIC), logic circuits, and any other circuit or processor capable of executing instructions. Processor 104 may be programmed to perform, alone or in combination, any of the processes, methods or functions described herein.

Memory device 106 stores instructions, executable by processor 104, for controlling gaming machine 100. For example, memory device 106 stores data such as one or more primary and/or community games, player identifying information, random or pseudo-random number generation software, pay table data, and/or other information or applicable game rules that relate to game play on gaming machine 100. Memory device 106 may include one or more forms of memory. For example, memory device 106 may include, without limitation, random access memory (RAM), read-only memory (ROM), flash memory, and/or electrically erasable programmable read-only memory (EEPROM). In some embodiments, other suitable magnetic, optical, and/or semiconductor-based memory may be included in memory device 106 by itself or in combination.

In the exemplary embodiment, gaming machine 100 includes a communication interface 108 to enable communication with one or more other gaming machines 100 and/or a gaming server (as described below), directly and/or through a network.

Gaming machine 100 includes a plurality of switches and/or buttons 110 that are coupled to a front 107 of cabinet 102. Buttons 110 may be used to start play of a primary and/or secondary game, such as a community game. One button 110 may be a “Bet One” button that enables the player to place a bet or to increase a bet. Another button 110 may be a “Bet Max” button that enables the player to bet a maximum permitted wager. Yet another button 110 may be a “Cash Out” button that enables the player to receive a token payment, a money payment or other suitable form of payment, such as a ticket or voucher, which corresponds to a number of remaining credits.

In the exemplary embodiment, gaming machine 100 includes a coin acceptor 112 for accepting coins and/or tokens, and a paper acceptor 114 for accepting and/or validating cash bills, coupons, tickets, and/or vouchers 116. Paper acceptor 114 may also be capable of printing tickets or vouchers 116. Furthermore, in some embodiments, paper acceptor 114 includes a card reader for use with credit cards, debit cards, identification cards, reward cards and/or smart cards. The cards accepted by paper acceptor 114 may include a magnetic strip and/or a preprogrammed microchip that includes a player's identification, one or more credentials, credit totals, and any other relevant information that may be used.

Moreover, in the exemplary embodiment, gaming machine 100 includes one or more presentation devices 118. Presentation devices 118 are mounted to and/or at least partially within cabinet 102 and controlled by processor 104, and may include a primary presentation device for displaying a primary game and/or a secondary presentation device for displaying a secondary, or community, game. Presentation devices 118 may include, without limitation, a plasma display, a liquid crystal display (LCD), a display based on light emitting diodes (LEDs), organic light emitting diodes (OLEDs), polymer light emitting diodes (PLEDs), and/or surface-conduction electron emitters (SEDs), a speaker, an alarm, and/or any other device capable of presenting information to a user. In the exemplary embodiment, presentation device 118 is a touch screen device, suitable to display information to a player and receive inputs from the player. In at least one embodiment, as shown in FIG. 2, one or more of buttons 110 may be incorporated into touch screen device 118.

Presentation device 118 is used to display one or more game images, symbols, a credit status, a gaming status and/or indicia such as a visual representation or exhibition of movement of an object such as a mechanical, virtual, or video reel, dynamic lighting, video images, and the like. Additionally, or alternatively, presentation device 118 displays images and indicia using mechanical means. For example, presentation device 118 may include an electromechanical device, such as one or more rotatable reels, to display a plurality of game or other suitable images, symbols, or indicia.

In an exemplary embodiment, gaming machine 100 includes a community game status display 120, which is provided to display a status of a community game and/or a status of one or more other players participating in the community game. Further, gaming machine 100 includes a credit display 122, which displays a player's current number of credits, cash, account balance, or equivalent. Additionally, gaming machine 100 also includes a bet display 124 which displays a player's amount wagered. Community game status display 120, credit display 122 and/or bet display 124 may be standalone displays independent of presentation device 118, or incorporated into presentation device 118.

In one embodiment, gaming machine 100 randomly generates game outcomes for primary games and/or community games using probability data. For example, each game outcome is associated with one or more probability values that are used by gaming machine 100 to determine the game output to be displayed. Such a random calculation may be provided by a random number generator, such as a true random number generator (RNG), a pseudo-random number generator (PNG), or any other suitable randomization process. Moreover, gaming machines 100 may be terminal-based machines, wherein the actual games, including random number generation and/or outcome determination, are performed at a gaming server. In such an embodiment, gaming machine 100 displays results of the game via presentation device 118.

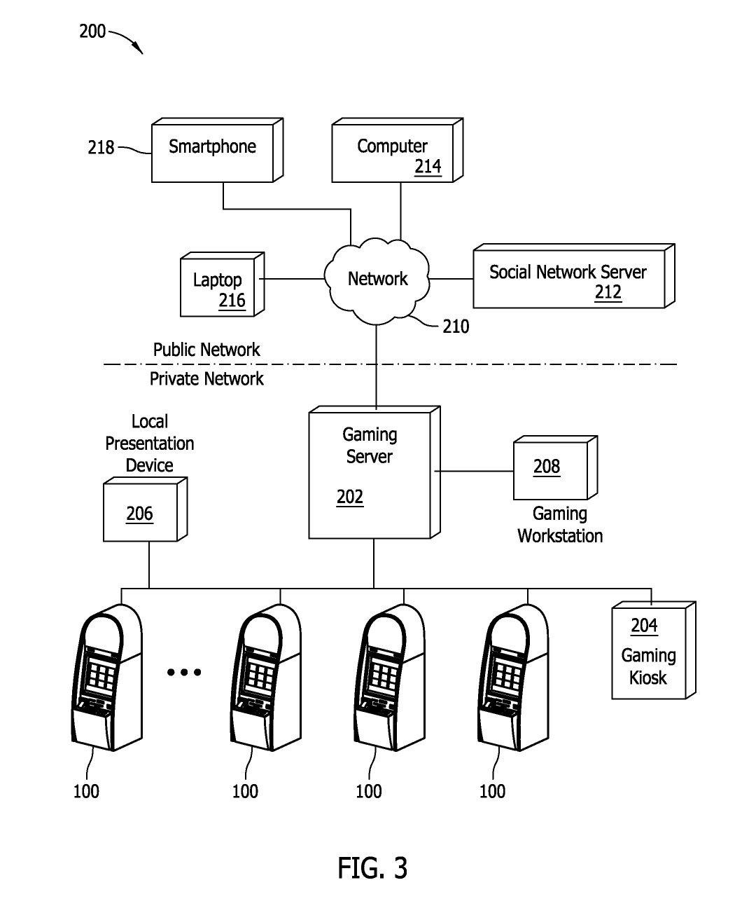

FIG. 3 illustrates an exemplary gaming system 200. In the exemplary embodiment, gaming system 200 includes a gaming server 202 coupled to a plurality of gaming machines 100. Gaming server 202 may perform a plurality of functions including, for example, game outcome generation, player tracking functions, and/or accounting functions. Gaming server 202 may include one server or a plurality of servers that together or separately perform one or more of functions described herein. Further, gaming system 200 may include a gaming kiosk 204, which is usable to, without limitation, print coupons, redeem coupons, cash-in tokens, view bonus statuses, enter player information, etc.

In the exemplary embodiment, gaming system 200 includes a local presentation device 206, which may be disposed at one or more locations throughout a gaming location, such as a casino. In one example, local presentation device 206 may be disposed above a group of gaming machines 100, proximate to gaming kiosk 204, and/or other locations viewable by one or more players. In one embodiment, local presentation device 206 is mounted proximate to a plurality of gaming machines 100 to display information related to one or more community games. In such an embodiment, local presentation device 206 may also display a leader-board of players of the community game and/or real-time or near real-time crediting of gaming activity to the community game, as a whole and/or per player. Gaming system 200 further includes a gaming workstation 208, which is often utilized by one or more employees of a gaming entity, such as a casino. Gaming workstation 208 may provide an employee access to gaming server 202 to enter identifying information about a player, such as name, contact information, rewards information, etc.

In general, gaming server 202, gaming machines 100 and gaming kiosk 204 are present within a gaming location, such as a casino. In various embodiments, one or more of gaming server 202, gaming machines 100 and/or gaming kiosk 204 may be spread across multiple gaming locations. In at least one embodiment, gaming machines 100 may be disposed at one or more locations other than a casino, such as bars, gas stations, etc.

In the exemplary embodiment, gaming system 200 also includes a network 210, to which gaming server 202 is connected. Network 210 may include, without limitation, the Internet, an intranet, a local area network (LAN), a cellular network, and/or a wide area network (WAN). It should be appreciated that gaming server 202 includes suitable security software to protect the integrity of gaming server 202, gaming machines 100 and/or any gaming activity associated with gaming server 202 and/or gaming machines 100. In one embodiment, network 210 may be included within a public network and gaming server 202 may be included within a private network, such as a network within the gaming location or locations including gaming server 202, gaming machines 100, and/or gaming kiosk 204. The private network may be isolated from the public network and/or network 210 via one or more suitable security systems, software, or hardware, such as, without limitation, one or more firewalls or virtual local area networks (VLANs).

As shown in FIG. 3, gaming system 200 includes a social network server 212 coupled to network 210. Social network server 212 may be any server hosting or providing access to one or more social networking websites. As such, gaming server 202 is able to communicate with a social network website, hosted or accessible by social network server 212, through network 210.

Additionally, gaming system 200 may include one or more gaming devices, such as a computer 214, a laptop or tablet computing device 216, and/or a smartphone 218, for example. The gaming devices are coupled to network 210 and may be located away from a gaming location or components thereof (e.g., gaming server 202 and gaming machines 100). The gaming devices may also be coupled to gaming server 202 and/or social network server 212.

Gaming system 200 is usable to create a community game. As used herein, the term “community game” refers to a secondary game hosted by a gaming entity, at gaming server 202, which is playable by a plurality of players and which pays an award once at least one predetermined condition (also referred to herein as a “win” or “winning” condition or combination) is satisfied. A community game may include, for example, an electronic bingo game, a virtual poker game, and/or any other game that enables gaming system 200 to function as described herein.

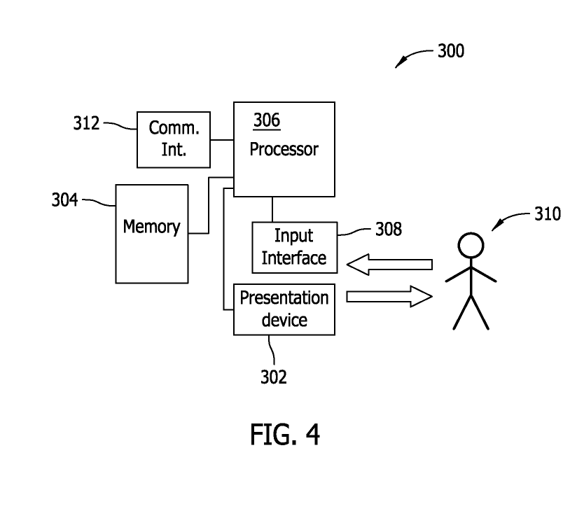

FIG. 4 illustrates an exemplary computing device 300. Each of gaming server 202, gaming kiosk 204, gaming workstation 208, social network server 212, computer 214, laptop or tablet computing device 216, and smartphone 218 are examples of computing devices 300. Computing device 300 includes a presentation device 302, a memory device 304 and a processor 306 in communication with presentation device 302 and memory device 304. Presentation device 302 may include, without limitation, a cathode ray tube (CRT) display, a liquid crystal display (LCD), an organic light emitting diode (OLED) display, or other suitable device for use in presenting information to a user.

Memory device 304 is any suitable device that may be used for storing and/or retrieving information, such as executable instructions and/or data, and is general consistent with memory device 106 described above. Processor 306 may include one or more processing units and may be programmed to perform alone or in combination with any of the processes, methods or functions described with respect to gaming system 200.

Computing device 300 includes an input device 308 for receiving input from user 310, such as a system administrator, IT professional, a gaming player, a social network user, etc. Input device 308 may include, without limitation, a keyboard, a pointing device, a mouse, a stylus, a touch sensitive panel (e.g., a touch pad or a touch screen), a gyroscope, an accelerometer, a position detector, and/or an audio input device. In one embodiment, the audio input device (i.e., input device 308) may be used with additional components to other devices via a frequency modulation scheme such as frequency-shift keying. A single component, such as a touch screen, may function as both presentation device 302 and input device 308. Further, computing device 300 includes a communication interface 312, to provide communication between computing device 300 and another computing device 300 and/or one or more networks, including, for example, network 210.

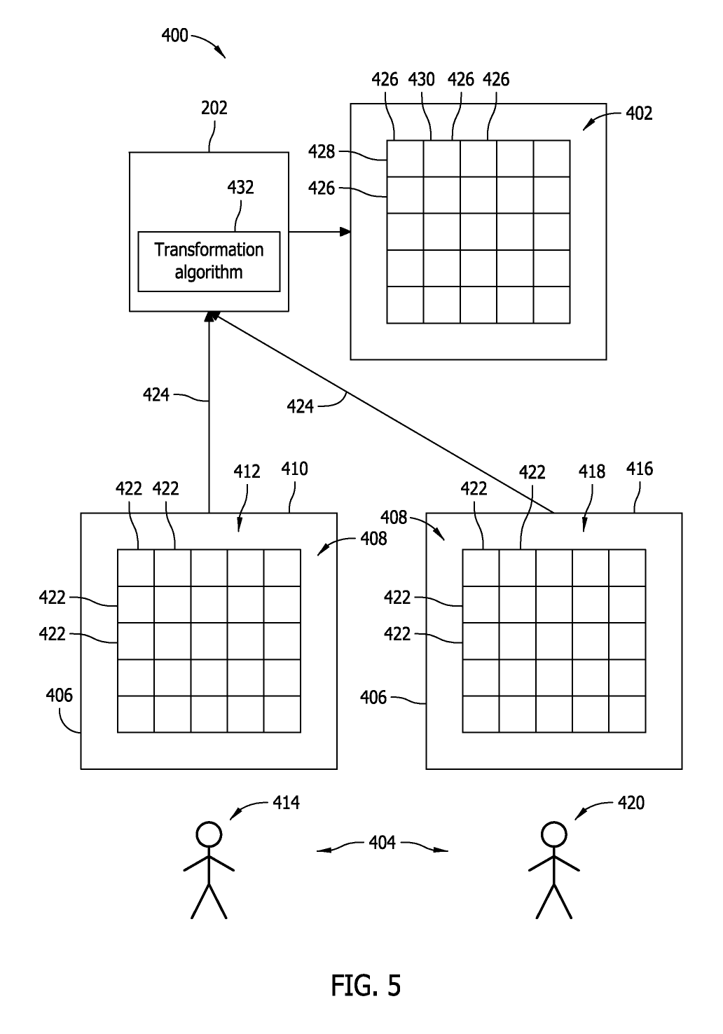

FIG. 5 is a block diagram of an exemplary gaming system 400 that provides a community game 402, such as a community electronic bingo game, to a plurality of players 404.

Gaming system 400 includes a plurality of gaming devices 406, and each gaming device 406 is playable by, and associated with, a player 404. Gaming devices 406 include, but are not limited to only including, gaming machines 100 (shown in FIG. 1), computers 214, laptops or tablet computing devices 216, and/or smartphones 218 (shown in FIG. 3). Each gaming device 406 displays at least one primary game 408 to player 404 using presentation device 302 (shown in FIG. 4).

As illustrated in FIG. 5, gaming system 400 includes a first gaming device 410 that displays a first primary game 412 to a first player 414, and a second gaming device 416 that displays a second primary game 418 to a second player 420. It should be recognized, however, that gaming system 400 may include any suitable number of gaming devices 406, primary games 408, and/or players 404 that enables gaming system 400 to function as described herein.

Each primary game 408 includes a plurality of primary game piece locations 422 for displaying a plurality of primary game pieces (not shown). In the embodiment shown in FIG. 5, each primary game 408 is an electronic bingo game playable by a player 404. Accordingly, in the exemplary embodiment, each primary game piece location 422 is a square or a rectangle in which a game piece, such as a number or a numbered ball, is displayed when a ball drop occurs. If player 404 matches a predetermined winning combination with the primary game pieces in primary game piece locations 422, player 404 may receive a payout or an award at gaming device 406 and/or at any other device or location within gaming system 400. Moreover, if player 404 matches the predetermined winning combination, an output 424 is transmitted from gaming device 406 to gaming server 202 for input into community game 402. Alternatively, player 404 may select one or more primary game piece locations 422 to associate with community game 402. The selected primary game piece locations 422 may be transmitted to gaming server 202 for input into community game 402, and/or any primary game pieces displayed within the selected primary game piece locations 422 may be transmitted to gaming server 202 for input into community game 402. Accordingly, output 424 from each primary game 408 may include a result of the game (e.g., whether player 404 matched a winning combination and/or which winning combination was matched), a primary game piece location 422, and/or a primary game piece displayed within one or more selected primary game piece locations 422.

In an alternative embodiment, each primary game 408 represents a plurality of sub-games such that each primary game piece location 422 illustrated within FIG. 5 is actually a sub-game. For example, the sub-games may include a plurality of bingo games, and primary game 408 may be a super bingo game that includes 25 bingo sub-games arranged in a 5×5 grid, a 90 ball bingo game arranged in a 9×3 grid, or any other number or arrangement of sub-games. Accordingly, in such an embodiment, outputs 424 may include results or other data of the bingo sub-games, and/or may include results or other data of the super bingo game.

Data representative of community game 402 is stored within gaming server 202 and is provided or presented to players 404 via one or more presentation devices, such as local presentation device 206 and/or presentation devices 118 or 302 of one or more gaming devices 406. Community game 402 includes a plurality of community game piece locations 426 for displaying a plurality of community game pieces. In the exemplary embodiment, community game 402 is a secondary bingo game that is playable by a group of players 404 that are playing associated primary games 408.

In the exemplary embodiment, community game piece locations 426 are assigned to players 404 based on outputs 424 of primary games 408 and/or gaming devices 406 associated with players 404. For example, if first player 414 matches a winning combination of first primary game 412, output 424 representative of the winning combination is transmitted to gaming server 202. Gaming server 202 causes community game 402 to reserve or assign a first community game piece location 428 to first player 414 such that a community game piece displayed within first community game piece location 428 is credited to, or associated with, first player 414. In a similar manner, if second player 420 matches a winning combination of second primary game 418, a second community game piece location 430 is reserved or assigned to second player 420.

Community game pieces are displayed within community game piece locations 426 as a result of a ball drop or another triggering event. The ball drop causes a community game piece (e.g., a number or a numbered ball in the bingo game example) to be displayed within each community game piece location 426, or within each community game piece location 426 that has been assigned to players 404. Alternatively, community game pieces are displayed as a result of outputs 424 of primary games 408. For example, a primary game piece displayed in primary game 408 (resulting from a ball drop within primary game 408, for example) may be transmitted to community game 402 and may be displayed in a community game piece location 426 associated with player 404 and/or associated with primary game piece location 422 in which the transmitted game piece is displayed. Accordingly, in the bingo game example described herein, community game 402 may share a ball drop with primary game 408, or community game 402 may use a separate ball drop from primary games 408.

Gaming server 202 determines whether any winning combinations have been matched within community game 402 periodically, upon completion of community game 402 (i.e., when community game pieces are displayed within all community game piece locations 426), when a new community game piece is displayed within community game 402, and/or upon an occurrence of any other event that enables gaming system 400 to function as described herein. If a winning combination is identified for one or more players 404, a payout or an award is credited to player 404. It should be recognized that the payout (and the winning combination) of community game 402 may be different than a payout and winning combination of each primary game 408.

In various embodiments, the community game payout may be incremented and/or decremented during the pendency of community game 402 based on the amount of gaming activity and/or an amount of wagers credited to community game 402 by one or more players 404. In one embodiment, gaming server 202 may adjust each player's share of the community game payout, as indicated in the payout instructions, during the pendency of community game 402, or according to the individual player's gaming activity and/or wagers credited to community game 402.

The community game payout may be limited to player 404 that triggers community game 402 or may be distributed to one or more players 404 of community game 402. In some embodiments, the community game payout may be divided equally amongst players 404 associated with community game 402. In another embodiment, the community game payout may be divided according to a percentage of the total gaming activity attributed to each player 404. As should be apparent, there are numerous ways the community game payout may be distributed amongst players 404 associated with community game 402.

In some embodiments, one or more primary games 408 are different, such as a different game type, than community game 402. For example, primary games 408 may be reel-based slot games, and community game 402 may be a bingo game. Accordingly, in such embodiments, gaming server 202 includes at least one transformation algorithm 432 that transforms or translates outputs 424 of primary games 408 into outputs that are usable with community game 402. For example, transformation algorithm 432 may translate particular reel symbols and/or reel positions (i.e., primary game pieces and/or primary game piece locations 422) to one or more numbers and/or locations in community game 402 (i.e., community game pieces and/or community game piece locations 426). Alternatively, transformation algorithm 432 may be included within one or more gaming devices 406 to translate or transform outputs 424 before transmitting outputs 424 to community game 402 via gaming server 202. In the exemplary embodiment, transformation algorithm 432 references a lookup table, a database, or another suitable data construct that identifies transformations between primary games 408 and community game 402.

It should be recognized that transformation algorithm 432 may be used even when primary game 408 is the same game type as community game 402. For example, primary game 408 may be a bingo game that includes 25 primary game piece locations 422 and that receives a plurality of primary game pieces (e.g., 6 numbers) during a ball drop or ball call. Transformation algorithm 432 may be used to translate or transform the plurality of primary game pieces to a single community game piece within a community game piece location 426, or to a plurality of community game pieces and/or community game piece locations 426. Alternatively, a single primary game piece and/or primary game piece location 422 may be translated or transformed to a single community game piece and/or community game piece location 426 as desired.

In one embodiment, the generation or assignment of community game pieces and/or community game piece locations 426 may be influenced by player 404 satisfying one or more enhancement conditions. The enhancement conditions may include redeeming one or more coupons received by player 404 (e.g., a drink coupon or a free play coupon), winning or achieving a predetermined result in one or more mini-games or play-for-fun games (e.g., games played on a social media website), completing one or more predetermined achievements (e.g., winning a predetermined number of sequential games or winning a predetermined payout amount), and/or any other condition that enables gaming system 400 to function as described herein. As used herein, the terms “mini-games” and “play-for-fun games” refer to games or applications, which do not provide the opportunity, within the games, to wager and/or win real money. Mini-games and play-for-fun games may, however, be utilized to provide opportunities to wager and/or win real money separate from the games, yet within gaming system 100.

Community game pieces and/or community game piece locations 426 may be influenced by the satisfaction of the enhancement conditions, for example, by upgrading community game pieces and/or community game piece locations 426, increasing the odds of receiving a more desirable community game piece and/or community game piece location 426, increasing a number of community game pieces and/or community game piece locations 426 assigned to player 404, replacing community game pieces and/or community game piece locations 426 with a new set of game pieces and/or locations, and/or any other enhancement that enables gaming system 400 to function as described herein. For example, if community game 402 is an electronic bingo game, one suitable enhancement provided as a result of an enhancement condition being satisfied may include assigning a desirable ball location (i.e., community game piece location 426) to player 404, such as an upper-left position or another corner position on a community game board. If, for example, community game 402 is a virtual poker game, one suitable enhancement provided as a result of an enhancement condition being satisfied may include upgrading a category of the next card drawn for player 404 such that a face card is drawn for player 404, or has a higher probability of being drawn for player 404 as compared to a non-enhanced card draw. The enhancements may be adjusted or influenced based on a rarity, a difficulty, or a value of the enhancement condition. For example, a more desirable enhancement may be given if the value of the enhancement condition satisfied by player 404 is greater than other, lesser, enhancement conditions.

In one embodiment, the enhancement condition is tailored to, or adjusted based on a partially completed community game 402 for player 404. For example, the enhancement condition may be adjusted based on a partially filled-in bingo community game card such that a community game piece and/or a community game piece location 426 is selected that increases the player's chance of winning the community game payout.

In another embodiment, a group of players 404 (also known as a “circle of friends”) may join together to play community game 402. The group of players 404 may join a public community game 402, for example, by playing at designated gaming machines 100 within a gaming location, or may join a private community game 402, for example, by sending a request to gaming server 202. Each player 404 may play a plurality of community games 402 (e.g., public community games 402 and/or private community games 402) concurrently such that a community game piece and/or a community game piece location 426 received by a player 404, or assigned to player 404, in one community game 402 is automatically duplicated or attributed to player 404 in each other community game 402 being played by player 404. For example, player 404 may be part of a first group of players 404 playing a first (public) community game 402 and may be part of a second group of players 404 playing a second (private) community game 402. A community game piece and/or a community game piece location 426 received by player 404 within first community game 402 may automatically be provided to player 404 and/or attributed to player 404 within second community game 402.

In one embodiment, players 404 within a group of players 404 may share community game pieces and/or community game piece locations 426 received during play of community game 402. For example, one player 404 may receive a community game piece and/or a community game piece location 426 may be assigned to player 404, and another player 404 within the group of players 404 may use the community game piece and/or community game piece location 426.

Additionally or alternatively, each player 404 may store, or reserve, one or more community game pieces and/or community game piece locations 426 received during play of a community game 402 for use in a later community game 402. The stored community game pieces and/or community game piece locations 426 may be shared among the group of players 404 or may be accessible by each player 404 within the group of players 404. In one embodiment, the ability to store community game pieces and/or community game piece locations 426 may be “unlocked,” or made available upon the satisfaction of a predetermined condition, such as an amount of gameplay of the group of players 404 exceeding a predetermined threshold, or any other suitable condition.

Moreover, in one embodiment, the group of players 404, or an identified leader of the group of players 404, may decide an action to take with respect to new community game pieces and/or community game piece locations 426 received by a player 404 within the group of players 404. For example, players 404, or the leader, may decide to discard a community game piece and/or a community game piece location 426 received earlier in favor of the newly received community game piece and/or community game piece location 426. Alternatively, the newly received community game piece and/or community game piece location 426 may be added to community game 402, or may be stored for later use as described above. It should be recognized that each player 404 of the group of players 404 may be located in different locations during play of community game 402, and/or may play community game 402 at different times (i.e., each player 404 may contribute to community game 402 at different times) than other players 404 in the group of players 404.

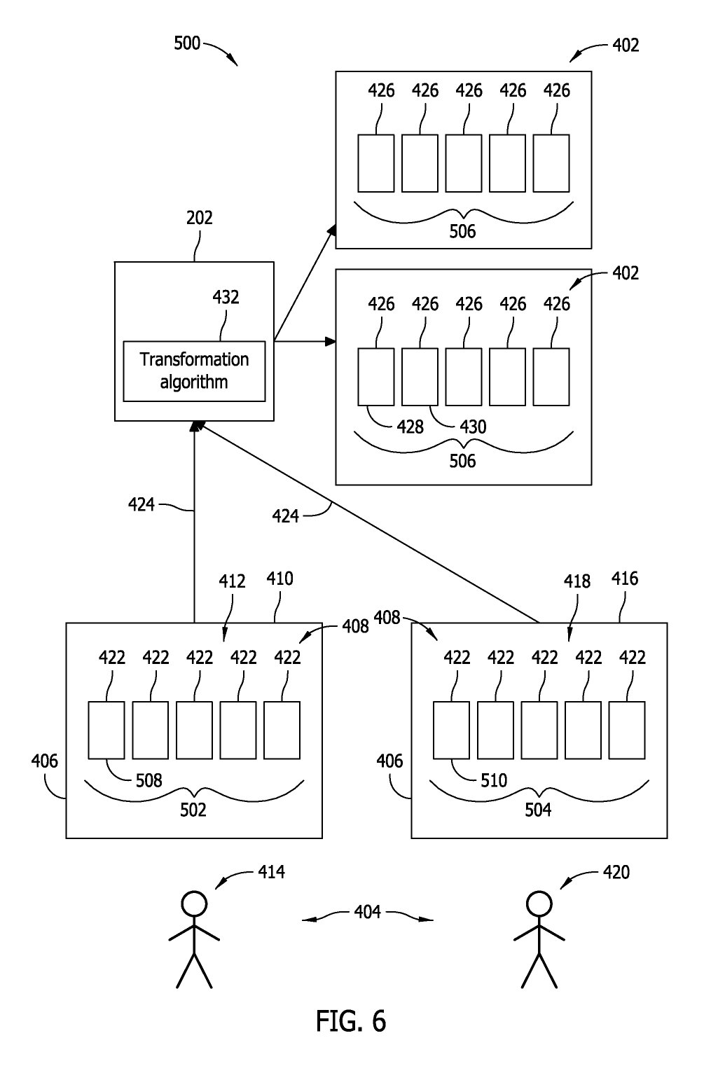

FIG. 6 is a block diagram of another exemplary gaming system 500 that provides a community game 402, such as a community video poker game, to a plurality of players 404. Unless otherwise specified, gaming system 500 is similar to gaming system 400 (shown in FIG. 5), and similar components are labeled in FIG. 6 with the same reference numerals used in FIG. 5.

In the exemplary embodiment, community game 402 is a community video poker game, and primary games 408 are primary video poker games. Additionally, as shown in FIG. 6, a plurality of community games 402 may be provided by gaming system 500 (or by gaming system 400 shown in FIG. 5). Accordingly, first primary game 412 displays a first primary hand 502 of virtual cards, second primary game 418 displays a second primary hand 504 of virtual cards, and community game 402 displays a community hand 506 of virtual cards.

During operation, players 404 may select one or more primary game piece locations 422 and/or game pieces (i.e., cards) to be used in community game 402. For example, first player 414 may select a first primary game piece location 508 to be used in community game 402, and may optionally select a first community game piece location 428 in which the primary game piece displayed in first primary game piece location 508 is to be used. Likewise, second player 420 may select a second primary game piece location 510 to be used in community game 402, and may optionally select a second community game piece location 430 in which the primary game piece displayed in second primary game piece location 510 is to be used. The virtual cards (i.e., primary game pieces) of the selected primary game piece locations 422 are transmitted as outputs 424 to gaming server 202 and to community game 402.

In an embodiment in which a plurality of community games 402 are provided, a selected primary game piece and/or a selected primary game piece location 422 may be assigned to each community game 402. Alternatively, player 404 may select different primary game pieces and/or primary game piece locations 422 to be assigned to each community game 402.

When community game 402 is completed (e.g., when all community game piece locations 426 have a virtual card assigned and/or displayed therein), community game 402 determines if any winning combinations exist in a similar manner as described above. Moreover, community game payouts are determined as described above.

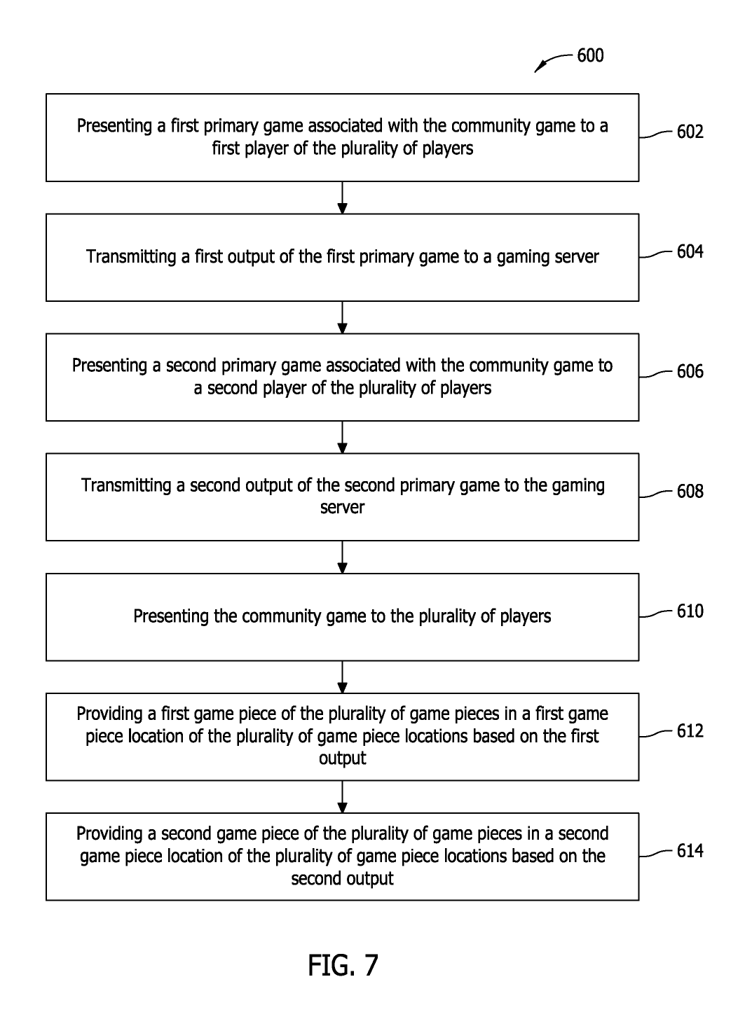

FIG. 7 illustrates an exemplary method 600 that may be executed by gaming system 200, gaming system 400 (shown in FIG. 5), and/or gaming system 500 (shown in FIG. 6) to provide a community game 402 (shown in FIG. 5). While method 600 is described with reference to gaming systems 200, 400, and 500, it should be understood that method 600 and/or other methods described herein are not limited to gaming systems 200, 400, and 500, and may be used with other gaming systems. Likewise, gaming systems 200, 400, and 500 should not be understood to be limited to method 600. In addition, while method 600 is described with respect to two players 404 and two gaming devices 406, it should be recognized that method 600 may be used with any suitable number of players 404 and/or gaming devices 406.

In the exemplary embodiment, method 600 includes presenting 602 a first primary game 412 associated with community game 402 to a first player 414 of a plurality of players 404 (all shown in FIG. 5). For example, first primary game 412 may be an electronic bingo game (as illustrated in FIG. 5), a virtual poker game (as illustrated in FIG. 6), and/or any other game. First primary game 412 is presented 602 on first gaming device 410 (shown in FIG. 5), for example, on presentation device 302 (shown in FIG. 4) or presentation device 118 (shown in FIG. 1).

When first player 414 plays first primary game 412, a first output of first primary game 412 is transmitted 604 to gaming server 202 and to community game 402. The first output may include, for example, a result of first primary game 412 and/or data representative of one or more primary game pieces and/or primary game piece locations 422 selected or identified by first player 414 and/or first gaming device 410.

In one embodiment, first primary game 412 is a different game type than community game 402 such that output 424 of first primary game 412 may not be usable with community game 402. Accordingly, in such an embodiment, first gaming device 410 and/or gaming server 202 include at least one transformation algorithm 432 (shown in FIG. 5) that transforms output 424 of first primary game 412 to an input to community game 402 that is usable with community game 402. It should be recognized that transformation algorithm 432 may also transform one or more outputs 424 of first primary game 412 to one or more inputs to community game 402 that are usable by community game 402 when primary game 412 is the same game type as community game 402.

In the exemplary embodiment, a second primary game 418 associated with community game 402 is presented 606 to a second player 420 in a similar manner as described above with reference to the presentation 602 of first primary game 412. When second player 420 plays second primary game 418, an output (i.e., second output) of second primary game 418 is transmitted 608 to gaming server 202 and to community game 402. The second output may include, for example, a result of second primary game 418 and/or data representative of one or more primary game pieces and/or primary game piece locations 422 selected or identified by second player 420 and/or second gaming device 416.

In one embodiment, first player 414 does not play first primary game 412 at the same time that second player 420 plays second primary game 418. Accordingly, data of community game 402 and/or outputs 424 of primary games 408 may be stored, for example, within gaming server 202, and community game 402 may be updated when players 404 return to playing community game 402 and/or primary game 408. As such, first player 414 and second player 420 may play primary games 408 at different times while still being able to play and contribute to the same community game 402.

Community game 402 is presented 610 to players 404, for example, using local presentation device 206 and/or presentation devices 118 and/or 302 of gaming devices 406. In one embodiment, primary games 408 and community game 402 are displayed on the same device, such as gaming device 406.

A first community game piece is provided 612 in a first community game piece location 428 based on output 424 of first primary game 412. For example, a number may be displayed in first community game piece location 428 if first player 414 matched a winning combination of first primary game 412. In another example, a primary game piece is selected (such as a number of a primary bingo game or a card of a virtual poker game) to be output by first primary game 412 and used in community game 402. The selected primary game piece is displayed in first community game piece location 428, or in another community game piece location 426 assigned to first player 414. In yet another example, a selection of a primary game piece location 422 is received from first player 414 to be used with community game 402. The game piece that is displayed in the selected primary game piece location 422 is output by first primary game 412 to be used in first community game piece location 428.

In one embodiment, first player 414 selects one or more desired community game piece locations 426 to be used with first primary game 412. Gaming server 202 receives the selection and assigns the selected community game piece locations 426 to first player 414 such that outputs 424 of first primary game 412 are used to display community game pieces in the selected locations 426.

In another embodiment, community game piece locations 426 are assigned, for example, by gaming server 202 based on a rate of play for each player 404. As used herein, the term “rate of play” refers to a rate at which player 404 plays and/or completes a primary game 408. Accordingly, players 404 who complete primary games faster than other players 404 may be assigned more community game piece locations 426 than the other players 404. It should be recognized that more community game piece locations 426 may equate to an increased chance to match a winning combination in community game 402.

In a similar manner as described above with reference to the first community game piece, a second community game piece is provided 614 in a second community game piece location 430 based on output 424 of second primary game 418. Further community game pieces are provided in other community game piece locations 426 until community game 402 is completed (i.e., all community game piece locations 426 are filled with community game pieces) or until a winning combination is identified.

In some embodiments, an indicator is associated with each player 404 to enable a player's contribution to community game 402 to be viewed. The player indicator is displayed at each community game piece location 426 associated with player 404. For example, each player 404 may be identified by a particular color (i.e., the player indicator) and each community game piece location 426 assigned to each player 404 is colored or shaded with that player's color.

In other embodiments, a plurality of community games 402 are provided, and at least one community game piece is provided within each community game 402 based on outputs 424 of primary games 408. For example, a single output 424 of each primary game 408 may be reflected in each community game 402.

When community game 402 is complete (e.g., when all outputs 424 of all primary games 408 have been received and/or when all community game piece locations 426 are filled) or if a winning combination is identified, gaming server 202 resolves, or determines, a payout of community game 402, for example, based on a paytable associated with community game 402. It should be recognized that a payout of community game 402 may be determined or resolved separately than a payout of each primary game 408.

In one embodiment, players 404 may select the paytable to be used with community game 402. Gaming server 202 receives a selection indicative of the paytable to be used, and resolves or determines the payout to one or more players 404 using the selected paytable.

Exemplary embodiments of systems and methods for providing community games are described herein. The systems and methods described herein may provide an enhanced gaming experience, where a player is able to compete or collaborate with other players to win a payout of a community game. In addition, results or other outputs of each player's primary game may be used in the community game. For example, players may select game pieces and/or game piece locations to be used in the community game, thus providing more interaction between the games and/or players as compared to at least some known gaming systems.

The systems and methods are not limited to the specific embodiments described herein but, rather, operations of the methods and/or components of the system may be utilized independently and separately from other operations and/or components described herein. Further, the described operations and/or components may also be defined in, or used in combination with, other systems, methods, and/or apparatus, and are not limited to practice with only the systems and methods as described herein.

A computer, controller, or server, such as those described herein, includes at least one processor or processing unit and a system memory. The computer, controller, or server typically has at least some form of non-transitory computer readable media. By way of example and not limitation, computer readable media includes, for example, a non-transitory computer storage device. Computer storage media include volatile and nonvolatile, removable and non-removable media implemented in any method or technology for storage of information such as computer readable instructions, data structures, program modules, or other data in a device.

Although the present disclosure is described in connection with an exemplary gaming system environment, embodiments of the invention are operational with numerous other general purpose or special purpose gaming system environments or configurations. The gaming system environment is not intended to suggest any limitation as to the scope of use or functionality of any aspect described herein. Moreover, the gaming system environment should not be interpreted as having any dependency or requirement relating to any one or combination of components illustrated in the exemplary operating environment.

Embodiments of the invention may be described in the general context of computer-executable instructions, such as program components or modules, executed by one or more computers or other devices. Aspects described herein may be implemented with any number and organization of components or modules. For example, aspects of the invention are not limited to the specific computer-executable instructions or the specific components or modules illustrated in the figures and described herein. Alternative embodiments of the invention may include different computer-executable instructions or components having more or less functionality than illustrated and described herein.

The order of execution or performance of the operations in the embodiments illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A gaming system comprising:
a gaming server configured to provide a community game playable by a plurality of players, wherein the community game comprises a plurality of game piece locations for displaying a plurality of game pieces;
a first gaming device communicatively coupled to said gaming server, said first gaming device configured to:
present a first primary game associated with the community game to a first player of the plurality of players; and
transmit a first output of the first primary game to said gaming server; and
a second gaming device communicatively coupled to said gaming server, said second gaming device configured to:
present a second primary game associated with the community game to a second player of the plurality of players; and
transmit a second output of the second primary game to said gaming server,
wherein said gaming server is further configured to provide a first game piece of the plurality of game pieces in a first game piece location of the plurality of game piece locations based on the first output, and to provide a second game piece of the plurality of game pieces in a second game piece location of the plurality of game piece locations based on the second output.

2. The gaming system of claim 1, further comprising a presentation device communicatively coupled to said gaming server, said presentation device configured to display the community game to the plurality of players.

3. The gaming system of claim 1, wherein said first gaming device comprises a presentation device configured to display the first primary game and the community game to the first player.

4. The gaming system of claim 1, wherein a payout is determined separately for each of the first primary game, the second primary game, and the community game.

5. The gaming system of claim 1, wherein the first primary game is a different game type than the community game.

6. The gaming system of claim 5, wherein said gaming server comprises a transformation algorithm configured to transform the output of the first primary game to an input usable with the community game.

7. The gaming system of claim 1, wherein said gaming server further comprises a transformation algorithm configured to transform the output of the first primary game to an input usable with the community game.

8. The gaming system of claim 1, wherein said first gaming device enables the first player to select a game piece of the first primary game to be used in the community game.

9. The gaming system of claim 1, wherein said gaming server is further configured to store the output of the first primary game and the output of the second primary game to enable the first player to play the first primary game at a different time than a time that the second player plays the second primary game.

10. The gaming system of claim 9, wherein said gaming server is configured to resolve a payout of the community game when the outputs of each primary game played by each of the plurality of players have been received.

11. The gaming system of claim 1, wherein said gaming server is configured to resolve a payout of the community game when the outputs of each primary game played by each of the plurality of players have been received.

12. The gaming system of claim 1, wherein said gaming server is further configured to receive a selection from the first player indicative of a game piece location of the community game, said gaming server provides a game piece associated with the output of the first primary game in the selected game piece location.

13. The gaming system of claim 1, wherein said gaming server is further configured to provide a plurality of community games, and provide at least one game piece in each of the plurality of community games based on the output of the first primary game.

14. The gaming system of claim 1, wherein said gaming server is further configured to receive a selection indicative of a paytable for the community game, said gaming server is further configured to resolve a payout of the community game using the selected paytable.

15. The gaming system of claim 1, wherein said gaming server is further configured to assign game piece locations of the community game to the first player based on a rate of play of the first primary game.

16. The gaming system of claim 1, wherein said gaming server is further configured to associate an indicator with each player and to cause the indicator of each player to be displayed at each game piece location associated with each player.

17. A method of providing a community game playable by a plurality of players, wherein the community game includes a plurality of game piece locations for displaying a plurality of game pieces, said method comprising:
presenting a first primary game associated with the community game to a first player of the plurality of players;
transmitting a first output of the first primary game to a gaming server;
presenting a second primary game associated with the community game to a second player of the plurality of players;
transmitting a second output of the second primary game to the gaming server;
providing a first game piece of the plurality of game pieces in a first game piece location of the plurality of game piece locations based on the first output; and
providing a second game piece of the plurality of game pieces in a second game piece location of the plurality of game piece locations based on the second output.

18. The method of claim 17, further comprising displaying the community game to the plurality of players using at least one presentation device.

19. The method of claim 17, further comprising displaying the first primary game using a presentation device and displaying the community game to the first player using the presentation device.

20. The method of claim 17, further comprising determining a payout separately for each of the first primary game, the second primary game, and the community game.

21. The method of claim 17, wherein the first primary game is a different game type than the community game, said method further comprising transforming the output of the first primary game to an input usable with the community game.

22. The method of claim 17, further comprising selecting a game piece of the first primary game to be used in the community game.

23. The method of claim 17, further comprising storing the output of the first primary game and the output of the second primary game to enable the first player to play the first primary game at a different time than a time that the second player plays the second primary game.

24. The method of claim 23, further comprising resolving a payout of the community game when the outputs of each primary game played by each of the plurality of players have been received.

25. The method of claim 17, further comprising resolving a payout of the community game when the outputs of each primary game played by each of the plurality of players have been received.

26. The method of claim 17, wherein the gaming server includes a transformation algorithm, said method further comprising transforming the output of the first primary game to an input usable with the community game using the transformation algorithm.

27. The method of claim 17, further comprising receiving a selection from the first player indicative of a game piece location of the community game, and providing a game piece associated with the output of the first primary game in the selected game piece location.

28. The method of claim 17, further comprising providing a plurality of community games, and providing at least one game piece in each of the plurality of community games based on the output of the first primary game.

29. The method of claim 17, further comprising receiving a selection indicative of a paytable for the community game, and resolving a payout of the community game using the selected paytable.

30. The method of claim 17, further comprising assigning game piece locations of the community game to the first player based on a rate of play of the first primary game.

31. The method of claim 17, further comprising associating an indicator with each player and causing the indicator of each player to be displayed at each game piece location associated with each player.

32. The method of claim 17, further comprising influencing at least one of the first game piece and the first game piece location upon a determination that a predetermined enhancement condition is satisfied by the first player.

33. The method of claim 17, wherein the first player is part of a first group of players, said method comprising sharing at least one of the first game piece and the first game piece location among the first group of players.

34. The method of claim 17, wherein the community game is a first community game, the first player and the second player are part of a first group of players playing the first community game, the first player is part of a second group of players playing a second community game, and wherein the first game piece provided in the first community game is automatically provided in the second community game.
